(19) United States
(12) Patent Application Publication
(10) Pub. No.: US 2022/0246121 A1
(43) Pub. Date: Aug. 4, 2022

(54) PORTABLE ELECTRONIC MUSICAL INSTRUMENT

(71) Applicant: Shusheng Zhong, Shanwei (CN)

(72) Inventor: Shusheng Zhong, Shanwei (CN)

(21) Appl. No.: 17/722,418

(22) Filed: Apr. 18, 2022

(51) Int. Cl. G10H 1/00; H04R 1/02; G10H 1/34; G10H 1/14

(52) U.S. Cl. CPC G10H 1/0008; H04R 1/025; G10H 1/34; G10H 1/14; G10H 2220/395; G10H 2220/005; G10H 2220/265; G10H 2210/415; G10H 2220/391

(57) ABSTRACT

An embodiment of the present disclosure provides a portable electronic musical instilment, including a press module, a control module, an angle detection module, and an audio play module; the press module is arranged above the control module; the angle detection module and the audio play module are respectively connected to the control module; the angle detection module is configured to detect a rotating angle of a portable electronic musical instrument body; the control module is configured to adjust, according to the rotating angle detected by the angle detection module, different registers; the press module is configured to receive a press event of a user; and the audio play module is controlled by the control module to play tones of different musical scales.

### TECHNICAL FIELD

The present disclosure relates to the technical field of electronic equipment, in particular to a portable electronic musical instrument.

### BACKGROUND

To operate an existing electronic organ, a support for placement is required, and the volume and weight of the support for placement are usually relatively large. if an operator wants to move during the performance, the operator needs to move the support for placement at the same time. This is very inconvenient. Most of the time, the support platform for placement can only be fixed at one position, which causes a great restriction on player's position and movement. The general electronic musical instilment is large in size, and the player needs to hold it with both hands to do performance, so that the operation flexibility is low, and it is not easy to cariy the electronic musical instrument.

### SUMMARY

In view of the above-mentioned problems, the embodiment of the present disclosure is proposed to provide a portable electronic musical instrument that solves the above-mentioned problems or at least partially solves the above-mentioned problems.

In order to solve the above-mentioned problems, an embodiment of the present disclosure discloses a portable electronic musical instrument, including:

a press module, a control module, an angle detection module, and an audio play module.

The press module is arranged above the control module; the angle detection module and the audio play module are respectively connected to the control module.

The angle detection module is configured to detect a rotating angle of a portable electronic musical instrument body. The control module is configured to adjust, according to the rotating angle detected by the angle detection module, different registers. The press module is configured to receive a press event of a user. The audio play module is controlled by the control module to play tones of different musical scales,

Preferably, the portable electronic musical instrument includes a power module; and the power module is connected to the control module and is configured to supply electric energy.

Preferably, the portable electronic musical instrument includes an input module; and the input module is connected to the control module and is configured to receive click information of a user.

Preferably, the input module includes keys or a touch screen.

Preferably, the portable electronic musical instrument includes a display screen; and the display screen is connected to the control module and is configured to display information.

Preferably, the portable electronic musical instrument includes a charging module; the display screen is connected to the control module; and the charging module is configured to transmit the electric energy to the power module.

Preferably, the portable electronic musical instrument includes a data interface; and the data interface is connected to the control module and is configured to output or input data to the control module.

Preferably, the audio play module includes a speaker; and the press module includes keys.

Preferably, the portable electronic musical instrument includes a semitone module; and the semitone module is connected to the control module to control, through the control module, the audio play module to play a semitone.

Preferably, the angle detection module includes a gravity sensor and an angular velocity sensor.

The embodiment of the present disclosure includes the following advantages:

In the embodiment of the present disclosure, the portable electronic musical instrument includes a press module, a control module, an angle detection module, and an audio play module; the press module is arranged above the control module; the angle detection module and the audio play module are respectively connected to the control module; the angle detection module is configured to detect a rotating angle of a portable electronic musical instrument body; the control module is configured to adjust, according to the rotating angle detected by the angle detection module, different registers; the press module is configured to receive a press event of a user; and the audio play module is controlled by the control module to play tones of different musical scales. The portable electronic musical instrument has a smaller size, is convenient to operate and carry, and is switched among bass, mid, and treble more quickly and fluently; the musical scale of one key is controlled with each finger more flexibly; furthermore, a perfect performance effect is achieved by cooperation of left and right hands; the operation is simple; and the performing rhythm is more fluent,

### BRIEF DESCRIPTION OF THE DRAWINGS

In order to explain the technical solutions of the embodiments of the present disclosure more clearly, the following will briefly introduce the accompanying drawings used in the description of the embodiments. Apparently, the drawings in the following description are only sonic embodiments of the present disclosure. Those of ordinary skill in the art can obtain other drawings based on these drawings without creative work.

FIG. 1 is a schematic diagram of a portable electronic musical instrument according to an embodiment of the present disclosure;

FIG. 2 is an exploded diagram of a portable electronic musical instrument according to an embodiment of the present disclosure;

FIG. 3 is an exploded diagram of a portable electronic musical instrument according to an embodiment of the present disclosure;

FIG. 4 is an exploded diagram of a portable electronic musical instrument according to an embodiment of the present disclosure;

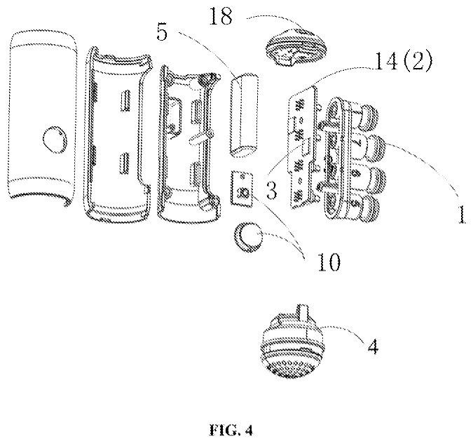

FIG. 5 is a schematic diagram of a portable electronic musical instrument according to an embodiment of the present disclosure;

FIG. 6 is a schematic diagram of use of a portable electronic musical instrument according to an embodiment of the present disclosure;

FIG. 7 is a schematic diagram of use of a portable electronic musical instrument according to an embodiment of the present disclosure;

FIG. 8 is a schematic circuit diagram of a portable electronic musical instrument according to an embodiment of the present disclosure;

FIG. 9 is an exploded diagram of a portable electronic musical instrument according to an embodiment of the present disclosure.

Press module 1, control module 2, angle detection module 3, audio play module 4, power module 5, input module 6, charging module 7, data interthce 8, display screen 9, soft rubber key cap 11, key decorating piece 12, key ejector pin 13, key circuit board 14, upper cover 16, lower cover 17, end seat 18, decorating plate 19, first communication module 20, semitone module 10, control module circuit 31, signal input switch circuit 32, audio power amplifier circuit 33, gravity sensor circuit 34, voltage stabilizing circuit 35, left and right hand piano key selection circuit 36, charging detection circuit 37, charging circuit 38, charging indicator circuit 39, and low-voltage detection circuit 40.

### DETAILED DESCRIPTION OF THE EMBODIMENTS

To make the technical problems solved by the embodiment of the present disclosure, the technical solutions, and the beneficial effects clearer, the embodiment of the present disclosure is further described below in detail with reference to accompanying drawings and embodiments. It should be understood that the specific embodiments described here are merely to explain the present disclosure, and not intended to limit the present disclosure.

It should be noted that when an element is referred to as being “fixed” to another element, it can be directly on the other element or an intermediate element may also exist. When an element is considered to be “connected” to another element, it can be directly connected to the other element or an intermediate element may be present at the same time. The terms “perpendicular”, “horizontal”, “left”,“right” and similar expressions used herein are for illustrative purposes only, and are not meant to be the only implementation modes.

Unless otherwise defined, all technical and scientific terms used herein are the same as meanings of general understandings of those skilled in the art of the disclosure. The terms used in the description of the present disclosure herein are merely to describe the specific implementation modes, not intended to limit the present disclosure. The term “and/or” used herein includes any and all combinations of one or more related listed items.

The “first” and “second” mentioned in the embodiments of the present disclosure do not represent a specific quantity and order, but are only used to distinguish names.

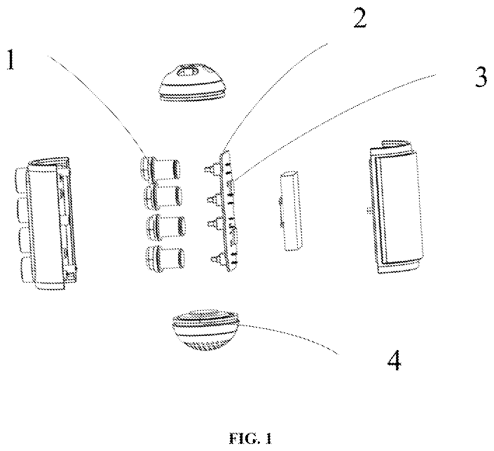

Referring to FIG. 1, a schematic diagram of a portable electronic musical instrument according to an embodiment of the present disclosure is illustrated. It may specifically include the following structures:

a press module 1, a control module 2, an angle detection module 3, and an audio play module 4.

In specific applications to the embodiment of the present disclosure, the press module 1 is arranged above the control module 2; and the angle detection module 3 and the audio play module 4 are respectively connected to the control module 2.

In the embodiment of the present disclosure, the angle detection module 3 is configured to detect a rotating angle of a portable electronic musical instrument body. The angle detection module 3 includes a gravity sensor and an angular velocity sensor, The rotating angle of the portable electronic musical instrument body is detected through the above gravity sensor and angular velocity sensor. Of course, the rotating angle of the portable electronic musical instrument body may also be detected in other ways. The embodiment of the present disclosure does not make many restrictions to this.

Further, the control module 2 may have a plurality of control functions. For example, it is configured to adjust, according to the rotating angle detected by the angle detection module 3, different registers. It should be noted that register is a part of a range, and may be divided into a treble area, a mid area, and a bass area. A produced tone can be adjusted to a corresponding register according to the detected rotating angle.

That is, in a storage unit of the control module 2, a mapping table between the rotating angle and the register can be preset. When a corresponding trigger condition is received, data of the mapping table can be called.

In addition, the control module 2 can also be configured to control the audio play module 4 to play tones of different musical scales. Further, a charging module 7 can also be controlled to perform charging and discharging. The embodiment of the present disclosure does not make many restrictions to this.

Specifically, the press module I is configured to receive a press event of a user, and the audio play module 4 is controlled by the control module 2 to play tones of different musical scales.

For example, when the user rotates the portable electronic musical instrument body, the control module 2 is triggered to adjust a tone to the treble area; after the press event of the user on the press module 1 is received, a tone of a corresponding musical scale is produced, such as high “la”.

In the embodiment of the present disclosure, the portable electronic musical instrument includes a press module 1, a control module 2, an angle detection module 3, and an audio play module 4; the press module 1 is arranged above the control module 2; the angle detection module 3 and the audio play module 4 are respectively connected to the control module 2; the angle detection module 3 is configured to detect a rotating angle of a portable electronic musical instrument body, the control module 2 is configured to adjust, according to the rotating angle detected by the angle detection module 3, different registers; the press module 1 is configured to receive a press event of a user, and the audio play module 4 is controlled by the control module 2 to play tones of different musical scales. The portable electronic musical instrument has a smaller size, is convenient to operate and carry, and is switched among bass, mid, and treble more quickly and fluently; the musical scale of one key is controlled with each finger most flexibly; furthermore, a perfect performance effect is achieved by cooperation of left and right hands; the operation is simple; and the performing rhythm is more fluent,

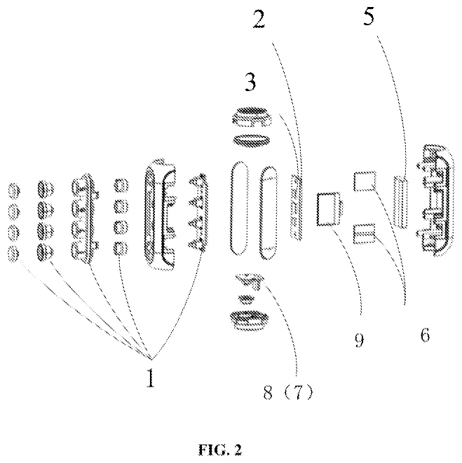

Referring to FIG. 2, an exploded diagram of a portable electronic musical instrument according to an embodiment of the present disclosure is illustrated. The portable electronic musical instrument may include a power module 5, an input module 6, a charging module 7, a data interface 8, and other modules. The embodiment of the present disclosure does not make many restrictions to this.

In the embodiment of the present disclosure, the control module 2 is connected to the power module 5, the input module 6, the charging module 7, the data interface 8, and other modules, respectively, and controls the functions of the corresponding modules. Specifically, the power module 5 is connected to the control module 2. The power module 5 is configured to supply electric energy. The power module 5 may include a battery. Specifically, the battery may be a nickel-cadmium battery, a nickel-metal hydride battery, a lithium battery, and the like. The embodiment of the present disclosure does not make many restrictions to the type of the battery.

In a further application to the embodiment of the present disclosure, the input module 6 may be connected to the control module 2, and the input module 6 is configured to receive click information of a user. The input module 6 includes keys or a touch screen, and the like. Of course, other input modules 6 may also be included, such as an input module 6 that is operated by means of gesture recognition. The embodiment of the present disclosure does not make many restrictions to this.

In one preferable embodiment, the portable electronic musical instrument includes a display screen 9; and the display screen 9 is connected to the control module 2 and is configured to display information. The display screen 9 may include a liquid crystal display (LCD) display screen 9, an organic electroluminesence display (OLED) flexible screen, a mini light emitting diode (LED) display screen 9, a micro LED display screen 9, and the like. The embodiment of the present disclosure does not make many restrictions to this.

In an actual application to the embodiment of the present disclosure, the portable electronic musical instrument includes the charging module 7; the display screen 9 is connected to the control module 2; and the charging module 7 is configured to transmit the electric energy to the power module 5. Specifically, the portable electronic musical instrument includes the data interface 8. The data interface 8 is connected to the control module 2 and is configured to output or input data to the control module 2. The data interface 8 and the charging module 7 can be integrated to a same interface, which is convenient for saying the space. The audio play module 4 includes a speaker.

It should be noted that when having a touch screen, the portable electronic musical instrument can include a corresponding touch integrated circuit (IC). The embodiment of the present disclosure does not make many restrictions to this.

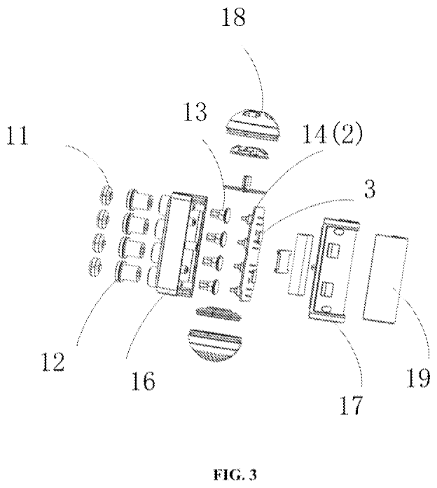

Referring to FIG. 3, an exploded diagram of a portable electronic musical instrument according to an embodiment of the present disclosure is illustrated. The press module 1 includes keys. Each key may include a soft rubber key cap 11, a key decorating piece 12, a key support, a key ejector pin 13, and a key circuit board 14. The key circuit board 14 is connected to the control module 2. The number of keys may be four or more than four. Tones of different musical scales are produced through the plurality of keys. For example, four keys respectively produce four musical scales: “do, re, mi, fa”, and four keys of another portable electronic musical instrument may produce another four musical scales: “sol, la, xi, do”. The embodiment of the present disclosure does not make many restrictions to this.

In the embodiment of the present disclosure, the portable electronic musical instrument may further include an upper cover 16, a lower cover 17, an end seat 18, a decorating plate 19, a wire, and other structural components or electrical components. The embodiment of the present disclosure does not make many restrictions to the type or number of the above structural components or electrical components.

It should be noted that the portable electronic musical instrument has a length of 95-110 mm, a width of 36-42 mm, and a height of 55-70 mm, which achieves a function of being held to do performance of the electronic musical instrument, and improves the convenience of use and carrying. Of course, the above sizes are only the examples of the embodiment of the present disclosure, and can also be other handheld size ranges changed by those skilled in the art according to an actual situation. The embodiment of the present disclosure does not make many restrictions to this.

Referring to FIG, 4, an exploded diagram of a portable electronic musical instrument according to an embodiment of the present disclosure is illustrated. The portable electronic musical instrument further includes a semitone module 10. The semitone module 10 is connected to the control module 2 to control, through the control module 2, the audio play module 4 to play a semitone. The semitone module 10 may include a semitone key and a semitone circuit board. The semitone circuit board may be connected to the control module 4 through a wire or in other connection ways (such as welding), which achieves a function of outputting a semitone and greatly enriches the function of the portable electronic musical instrument.

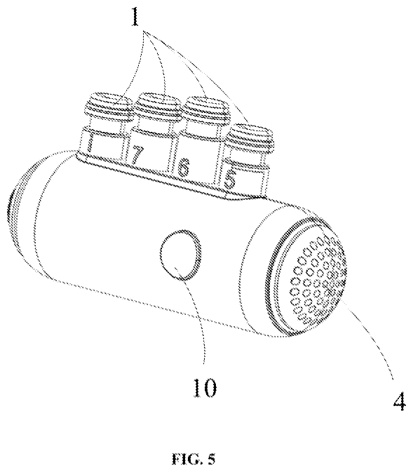

Referring to FIG. 5, a schematic diagram of a portable electronic musical instrument according to an embodiment of the present disclosure is illustrated. The semitone module 10 may be provided on a side edge of the portable electronic musical instrument, so that the use convenience of a user is improved.

In order to make those skilled in the art better understand the embodiment of the present disclosure, the following describes one specific example:

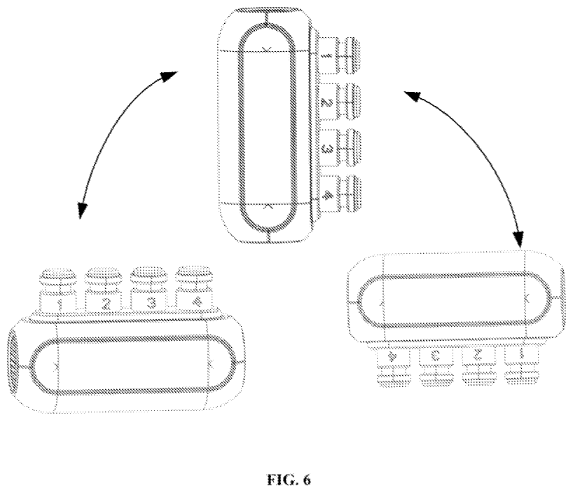

Specifically, referring to FIG. 6, a schematic diagram of use of a portable electronic musical instrument according to an embodiment of the present disclosure is illustrated, as follows: 1. A user holds the portable electronic musical instrument with a hand, with the speaker upward. During the performance, when the various keys are pressed, a gyroscope or gravity accelerator will recognize an angle state, and the musical instrument is mid. 2. The user holds the portable electronic musical instrument with a hand, with the speaker fell down to the left. During the performance, when the various keys are pressed, the gyroscope or gravity accelerator will recognize a change of the angle state, and the musical instrument is bass. 3. The user holds the portable electronic musical instrument with a hand, with the speaker fell down to the right. During the perfor uance, when the various keys are pressed, the gyroscope or gravity accelerator will recognize a change of the angle state, and the musical instrument is treble.

Specifically, the gravity sensor can measure motion acceleration values in three dimensions, which are represented by digits of three dimensions x, y, z. When the musical instrument is stationary, although there is no movement, there is still a gravity acceleration in a vertical direction. Therefore, changes of the gravity accelerations in three directions can be measured in the stationary state. For example, when a printed circuit hoard (PCB) of the portable electronic musical instrument is vertical, x=z=0, and y=g. When the PCB of the portable electronic musical instrument and a vertical line form a degrees, x=g*sin a, y=g*cos a, and z=0. The values of x, y, and z can be read from the sensor, thus calculating corresponding angles a. That is, an angle represents a register. Different registers correspond to a certain angle range. For example, (−180, −45), (−45, −45), and (45, 180) are defined to be three registers, which are respectively a treble area, a mid area, and a bass area.

For example, a finger piano is held with the left hand, with the speaker upwards, and a benchmark area is the mid area. The bass area is rotated from the benchmark area from the right to a certain angle, and the treble area is rotated from the benchmark area from the left to a certain angle. In the same way, the finger piano is held with the right hand, with the speaker upwards. The benchmark area is the mid area. The bass area is rotated from the benchmark area to the right. The treble area is rotated from the benchmark area to the left. The user can hold the portable electronic musical instrument, and dance while playing corresponding music. The portable electronic musical instrument has a light weight and a small volume, and is very suitable for the performance in the form of singing and dancing joyously.

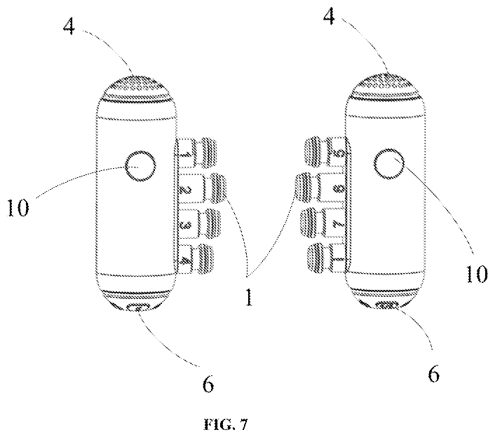

Referring to FIG. 7, a schematic diagram of use of a portable electronic musical instrument according to an embodiment of the present disclosure is illustrated. Specifically, the portable electronic musical instrument may be divided into a “left hand piano” and a “right hand piano”. The user holds the “left hand piano” with the left hand, and holds the “right hand piano” with the right hand. The four keys of the “left hand piano” can respectively produce four musical scales: “do, re, mi, fa”, and the four keys of the “right hand piano” can respectively produce four musical scales: “sol, la, xi, do”, so that the performance can be done with two hands, without auxiliary devices such as a seat, and a support, and the convenience of the performance is greatly improved.

In one preferable embodiment, the input module 6, the charging module 7, and the data interface 8 can be arranged at the end seat 18, so that the space is saved; the use convenience of the user is improved; the integration degree is high; and the cost is reduced.

Specifically, the input module 6 may include an on-off key, a volume key, a tone key, a musical instrument selection key, and the like. The embodiment of the present disclosure does not make many restrictions to this. Of course, the end seat 18 can also be provided with a charging indicator and other components. The embodiment of the present disclosure does not make restrictions to this.

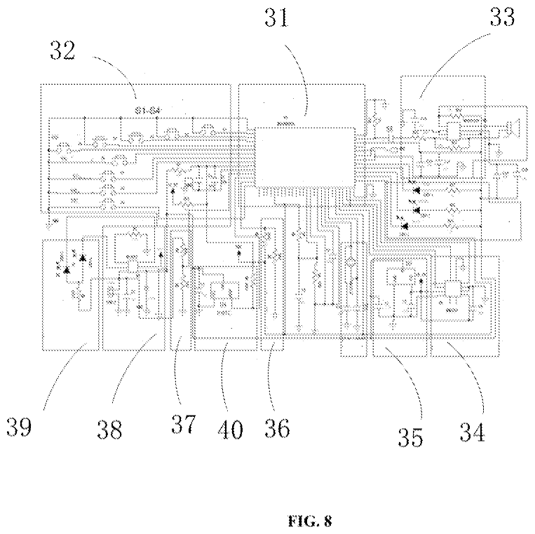

Referring to FIG. 8, a schematic circuit diagram of a portable electronic musical instrument according to an embodiment of the present disclosure is illustrated. A control module circuit 31 is connected to a signal input switch circuit 32 (that is, a note key circuit, an on-off key circuit, a volume key circuit, and the like), an audio power amplifier circuit 33, a gravity sensor circuit 34, a voltage stabilizing circuit 35, a left and right hand piano key selection circuit 36, a charging detection circuit 37, a charging circuit 38, a charging indicator circuit 39, and the like, respectively. Of course, other circuits can also be included, such as a low-voltage detection circuit 40. The embodiment of the present disclosure does not make many restrictions to this.

It should be noted that the signal input switch circuit 32 may include note key circuits from S1 to S4; S5 is the on-off key circuit; S6 is the musical instrument selection key circuit; S7 is the volume key circuit; S8 is the tone key circuit; S9 is the semitone circuit. Of course, those skilled in the art can also set any key circuit according to an actual situation. The embodiment of the present disclosure does not make many restrictions to this.

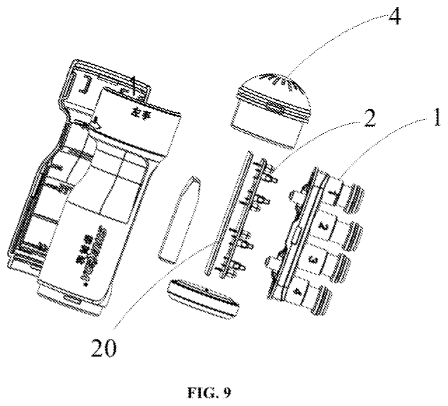

In one actual application, referring to FIG. 9, an exploded diagram of a portable electronic musical instrument according to an embodiment of the present disclosure is illustrated. The portable electronic musical instrument may include a first musical instrument and a second musical instrument. The first musical instrument communicates with the second musical instrument. Specifically, the first musical instrument includes a first communication module 20, and the second musical instrument may include a second communication module. The first communication module 20 of the first musical instrument can communicate with the second communication module of the second musical instrument.

The type of the first communication module 20 and the second communication module may include a Bluetooth communication module, a near field communication (NFC) module, a 2.4G wireless communication module, and other various communication modules. Various communication modules can also be adopted. The embodiment of the present disclosure does not make many restrictions to this.

For example, the first musical instrument is provided with a 2.4G wireless communication module, and the second musical instrument is also provided with a 2.4G wireless communication module. The first musical instrument and the second musical instrument communicate with each other through the 2.4G wireless communication modules arranged on them.

For specific content of the communication, the control module 2 of the first musical instrument can generate music setting information, and control the 2.4G wireless communication module to send the music setting information to the 2.4G wireless communication module of the second musical instrument. The 2.4G wireless communication module receives the music setting information and synchronizes the music setting information to the second musical instrument.

The music setting information can include composition, instrument timbre, tone, and other setting information. The embodiment of the present disclosure does not make many restrictions to this.

The above describes the portable electronic musical instrument provided by the present disclosure in detail. Specific examples are used herein to illustrate the principle and implementation modes of the present disclosure. The descriptions of the above embodiments are only used to help understand die method and its key thoughts of the present disclosure. Moreover, for those of ordinary skill in the art, according to the ideas of the present disclosure, there will be changes in the specific implementation modes and the scope of application. In summary, the content of this specification should not be construed as limiting the present disclosure.

What is claimed is

1. A portable electronic musical instrument, comprising:
a press module, a control module, an angle detection module, and an audio play module, wherein
the press module is arranged above the control module; the angle detection module and the audio play module are respectively connected to the control module;
the angle detection module is configured to detect a rotating angle of a portable electronic musical instrument body; the control module is configured to adjust, according to the rotating angle detected by the angle detection module, different registers; the press module is configured to receive a press event of a user; and the audio play module is controlled by the control module to play tones of different musical scales.

2. The portable electronic musical instrument according to claim 1, wherein the portable electronic musical instrument comprises a power module; and the power module is connected to the control module and is configured to supply electric energy.

3. The portable electronic musical instrument according to claim 1, wherein the portable electronic musical instrument comprises an input module; and the input module is connected to the control module and is configured to receive click information of a user.

4. The portable electronic musical instrument according to claim 1, wherein the portable electronic musical instillment comprises a first musical instrument and a second musical instrument;
the first musical instrument comprises a first communication module; the second musical instrument comprises a second communication module; and the first communication module of the first musical instrument communicates with the second communication module of the second musical instrument. 5.

5. The portable electronic musical instrument according to claim 1, wherein the portable electronic musical instrument comprises a display screen; and the display screen is connected to the control module and is configured to display information.

6. The portable electronic musical instrument according to claim 1, wherein the portable electronic musical instilment comprises a charging module; the display screen is connected to the control module; and the charging module is configured to transmit the electric energy to the power module.

7. The portable electronic musical instrument according to claim 1, wherein the portable electronic musical instrument comprises a data interface; and the data interface is connected to the control module and is configured to output or input data to the control module.

8. The portable electronic musical instrument according to claim 1, wherein the audio play module comprises a speaker; and the press module comprises keys.

9. The portable electronic musical instrument according to claim 1, wherein the portable electronic musical instrument comprises a semitone module; and the semitone module is connected to the control module to control, through the control module, the audio play module to play a semitone.

10. The portable electronic musical instrument according to claim 1, wherein the angle detection module comprises a gravity sensor and an angular velocity sensor.
